(19) United States
(12) Patent Application Publication
(10) Pub. No.: US 2026/0012478 A1
(43) Pub. Date: Jan. 8, 2026

(54) Systems and Methods for Detecting and Mitigating Cyber Attacks on Converter-Based Energy Equipment and Associated Communication Networks

(71) Applicant: DER Security Corp., Scotts Valley, CA (US)

(72) Inventors: Jay Johnson, Albuquerque, NM (US); Kudrat J. Kaur, Hillsboro, OR (US); Jorge D. Pineda Alvarado, Atlanta, GA (US)

(73) Assignee: DER Security Corp., Scotts Valley, CA (US)

(21) Appl. No.: 19/257,190

(22) Filed: Jul. 1, 2025

Related U.S. Application Data
(60) Provisional application No. 63/667,058, filed on Jul. 2, 2024.

(51) Int. Cl. H04L 9/40

(52) U.S. Cl. CPC H04L 63/1441; H04L 63/1416

(57) ABSTRACT

Extensive deployment of interoperable grid-connected systems and devices, such as grid-connected communications equipment, power-conversion devices, or power-generation devices, including inverter-based resources (IBR), distributed energy resources (DER), electric vehicle supply equipment (EVSE), and similar devices is increasing the power system cybersecurity attack surface. Systems and methods are provided for minimizing the risks to grid-connected systems using an engineered control system to detect and mitigate malicious system operations. Malicious operations are mitigated by analyzing measurement data from grid-connected devices for consistency or comparing this data against other grid-connected devices, models of devices, or other parameters, such as simulations, on-site or remote power sensors, power system simulations, historical operations, or known operating characteristics for such grid-connected devices. Communication-based cybersecurity detection capabilities are also provided based on non-permitted writing or reading values, attempts at writing read-only points, or capturing protocol-specific errors or exceptions.

### PRIORITY CLAIM

This application claims priority to U.S. Provisional App. Ser. No. 63/667,058, filed on Jul. 2, 2024, and entitled: “Systems and Methods for Detecting and Mitigating Cyber Attacks on Converter-Based Energy Equipment and Associated Communication Networks,” the entire disclosure of which is hereby incorporated by reference herein.

### FIELD

The present patent document relates generally to the security of grid-connected systems, including systems with grid-connected communications equipment, power-conversion devices, or power-generation devices. These systems include, for example, systems using inverter-based resources (IBR), distributed energy resources (DER), and/or electric vehicle supply equipment (EVSE). In particular, the present patent document relates to systems and methods to detect and mitigate cyber-attacks on such grid-connected systems.

### BACKGROUND

Cyber-secure, resilient energy is paramount to the prosperity of developed nations. Traditionally, power systems have operated with dedicated communication channels to large generators and utility-owned assets, but there is now reliance on grid-connected devices (e.g., IBR, DER, EVSE, and/or similar devices) that use the Internet and/or other shared networks for communication to provide power generation, reactive power controls, protection features, and dynamically adjust intelligent loads. Such devices are used in grid-connected systems, such as systems using grid-connected communications equipment, power-conversion devices, or power-generation devices (e.g., IBR, DER, EVSE, and/or similar systems). The interconnection of power electronics-interfaced DER, like photovoltaic (PV) inverters, Electric Vehicle Supply Equipment (EVSE), and/or battery energy storage systems (BESS), has been increasing worldwide for the last two decades for various reasons, including renewable portfolio standards, environmental requirements, and customer preference.

DER equipment can perform reactive power control and voltage regulation, active power control and frequency regulation, and protection functionalities when programmed to use these control modes. Grid-connected systems typically include communication interfaces that provide control over a range of commanded and autonomous functionalities, such as:
a. Reactive power control and voltage regulation—constant power factor, voltage-reactive power mode, dynamic reactive power mode, voltage-active power mode, active power-power factor mode, etc.
b. Active power control and frequency regulation—active power setpoints and curtailment, charging and discharging settings, frequency-active power mode, frequency-droop mode, ramp rates, etc.
c. Protection functionality—low and high frequency ride-through and trip settings, low and high voltage ride-through and trip settings, connect/disconnect settings, island detection, etc.

Grid-support functionalities are the subject of certain global interconnection standards like the Institute of Electrical and Electronics Engineers (IEEE) Std. 1547-2018 in the United States. These grid-support functions help maintain the stability and reliability of the power grid by dynamically adjusting intelligent loads, providing power generation, and reactive power controls. However, if these functions are manipulated locally or in-transit, it may cause maloperation of the devices or the monitoring and control systems. Therefore, ensuring cybersecurity of these systems is important to prevent malicious operations and maintain grid stability.

PV inverters, EVSE, BESSs, and/or other DER/IBRs also have standardized communication interfaces that are often used to communicate to utilities, aggregators, or other grid operators over the public internet, expanding the attack surface and increasing potential attack exposure. Grid-connected systems (e.g., IBR, DER, and/or EVSE) may be equipped with a range of grid-support functions and monitoring functionality, in accordance with various global interconnection standards. For example, if manipulated locally or in-transit, the IEEE 1547 grid-support functions and measurement data may cause maloperation of the devices or the monitoring and control systems.

Standardized communication interfaces are used by asset owners, utilities, aggregators, and other grid operators. These communication protocols include, for example, Modbus, IEEE 1815 (DNP3), IEC 61850, Open Charge Point Protocol (OCPP), ANSI/ASHRAE 135/ISO 16484-5 (BACnet), controller area network bus (CAN bus), EEBus, and IEEE 2030.5, and other network protocols that transfer measurement data or control settings. Modbus is sometimes used for its simplicity and ease of implementation, while IEEE 2030.5 is sometimes used over wide area networks for its client-server architecture and security features. These protocols enable DER systems to provide real-time data, receive control commands, and ensure seamless integration with the power grid, enhancing grid stability and reliability.

A range of potential threats may be sources of maloperation. FIG. 1 shows a system 100 illustrating several of these threats and the associated attack vectors. Malicious insiders at the head-end system or at the vendor or aggregator levels with access to management systems or head-end systems for grid-connected systems (e.g., IBR, DER, and/or EVSE systems) could issue bad settings to the equipment. By way of example, cloud services, networking infrastructure, or application programming interfaces (APIs) could be compromised to give adversaries access to change settings in the equipment through direct control or malicious firmware updates. Additionally, adversaries could gain local access to the equipment and modify the operation of the devices through local human-machine interfaces, maintenance terminals, or other means. Supply chain attacks, where undisclosed hardware or software components or functions are built into the product, could also provide an additional point of unauthorized ingress into the system.

There are many documented cases of vulnerabilities and cyberattacks on grid-connected devices (e.g., DER, IBR, and/or EVSE equipment) and networks. Examples of cyberattacks on EVSE equipment are described in the following paper: J. Johnson et al., “Review of Electric Vehicle Charger Cybersecurity Vulnerabilities, Potential Impacts, and Defenses,” Energies 2022, 15, 3931. Examples of cyberattacks on PV systems are documented in J. Johnson, “Public History of Solar Energy Cyberattacks and Vulnerabilities,” DERSEC-SOLAR-VULNS-2.0, DER Security White Paper, 2025.

If parameters of grid-connected devices are misconfigured or changed maliciously, the orchestrated control of power systems may not work as intended. If measurement or status data is falsified from the grid-connected devices (e.g., IBR, DER, and/or EVSE devices), coordinated control operations of the grid-operator or management service may be impacted.

Power system impacts from cyberattacks on DER equipment, for example, are described at the distribution and transmission levels in the following papers: J. Johnson et al., “Power System Effects and Mitigation Recommendations for DER Cyber Attacks,” IET Cyber-Physical Systems: Theory & Applications, January 2019 and J. Johnson et al. “Cybersecurity for Electric Vehicle Charging Infrastructure” SAND2022-9315 July 2022. Cyberattacks on the distribution level can lead to significant overvoltage or undervoltage conditions; whereas attacks affecting transmission level can trigger protection equipment operations which result in localized blackouts.

Sometimes the variations in a device's expected performance can indicate an attack or security breach of some sort. For example, the expected voltage versus reactive power (var) profile of a device may not match the expected or calculated behavior. FIG. 2 shows voltage-reactive power profiles 201, 202 for two different “Equipment Under Test” (EUT) devices for a range of irradiance conditions across a range of grid voltage conditions. FIG. 2 is from the following paper: J. Hernandez-Alvidrez, Javier & J. Johnson, “Parametric PV Grid-Support Function Characterization for Simulation Environments,” IEEE PVSC, 2017. In this figure, the Q value does not match the expected f(V, P) output. This is represented in FIG. 2 for two different products. The two devices shown in FIG. 2 have different offsets at nominal voltage and different characteristics compared to the programed volt-var curve (solid lines).

Accordingly, it is desirable to develop systems and methods for mitigating such cyberattacks, including cyberattacks on grid-connected systems, including systems with grid-connected communications equipment, power-conversion devices, or power-generation devices (e.g., IBR, DER, EVSE and/or similar systems).

### SUMMARY

Systems and methods for mitigating cyberattacks on grid-connected systems, including systems with grid-connected communications equipment, power-conversion devices, or power-generation devices (e.g., IBR, DER, EVSE and/or similar systems) are disclosed herein. Embodiments described herein may include detecting and mitigating falsified messages, abnormal operations, or abnormal commands in grid-connected systems with an intrusion detection system (IDS) or intrusion prevention system (IPS) by providing engineered control systems and methods that prevent malicious network traffic, reverts settings of devices on grid-connected systems (e.g., IBR, DER, EVSE, and/or similar systems), modifies access management systems, alerts system operators, and/or modifies network system equipment or architecture. The system and methods of the embodiments described herein may operate based on pre-programmed malicious signatures, context-aware settings and measurements, behavioral characteristic rules that represent undesired operating conditions of grid-connected systems, and/or detection mechanisms for falsified data of devices on grid-connected systems (e.g., IBR, DER, EVSE, and/or similar devices).

Detection and mitigation systems and methods for networked equipment, such as equipment for grid-connected systems are disclosed that include or make use of an engineered control system located within the management system, protocol translator, network equipment, or other components of grid-connected systems. The engineered control system is configured to detect and mitigate undesired operating conditions of devices on grid-connected systems or falsified data of devices on such grid-connected systems.

Detection and mitigation systems and methods for networked equipment, such as grid-connected devices on grid-connected systems, are disclosed that include or make use of an engineered control system located at communication network nodes between, for example, grid-connected systems and a management system.

Detection and mitigation systems and methods for networked equipment, such as equipment for grid-connected systems (e.g., IBR, DER, EVSE, and/or similar systems), are disclosed with the ability to actively query or passively monitor one or more grid-connected device (e.g., IBR, DER, EVSE, and/or similar devices), forecasting tools, meteorological sensors, on-site or remote power sensors, meters, or databases to get accurate estimates of system state and operations.

Detection and mitigation systems and methods for networked equipment, such as equipment like grid-connected devices for use on a grid-connected system (e.g., IBR, DER, EVSE, and/or similar systems), are provided that include or make use of analytical or numerical modelling, digital twins, or machine learning techniques to estimate physical equipment operations and measurement data.

### BRIEF DESCRIPTION OF THE DRAWINGS

The accompanying drawings, which are included as part of the present specification, illustrate the presently preferred embodiments and, together with the general description given above and the detailed description given below, serve to explain and teach the principles of the systems and methods described herein.

FIG. 1 is an illustration of different cyberattack scenarios on a DER, IBR, EVSE or similar system.

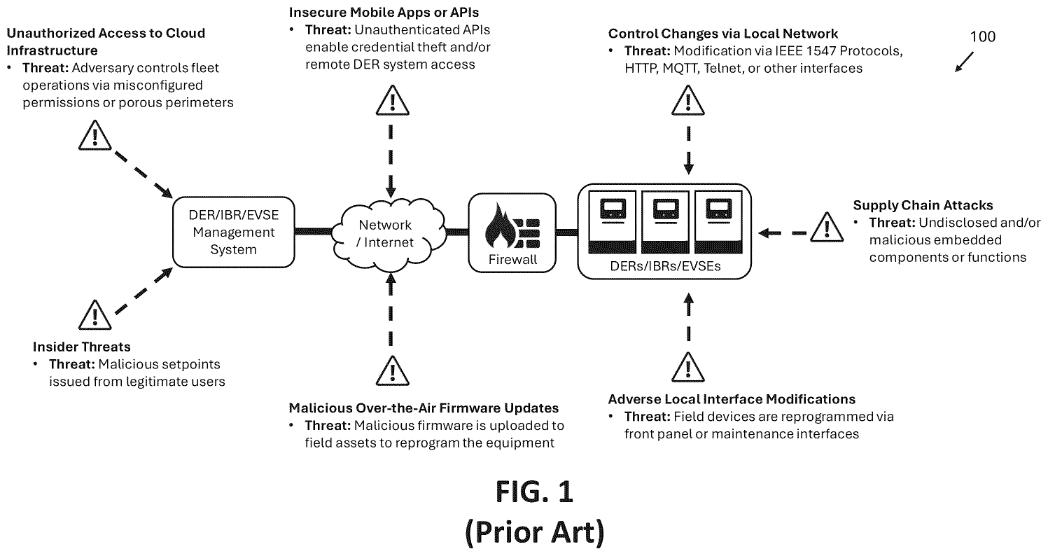

FIG. 2 is the voltage-reactive power profiles for two Equipment Under Test (EUT) devices.

FIG. 3 is an overview of an environment in which the various embodiments described herein can be used.

FIG. 4 is a block diagram of an example of engineered control system logic that can be used with the systems and methods described herein.

FIG. 5 is a diagram showing an example control system network architecture for IBR, DER, EVSE, and/or similar systems with multiple example locations where the systems and methods described herein can be deployed in the network.

The figures are only intended to facilitate the description of the various embodiments described herein. The figures do not describe every aspect of the teachings disclosed herein and do not limit the scope of the claims.

### DETAILED DESCRIPTION

The following description is presented to enable any person skilled in the art to create and use systems and methods for detecting and mitigating cyberattacks on grid-connected systems, including systems with grid-connected communications equipment, power-conversion devices, or power-generation devices (e.g., IBR, DER, EVSE and/or similar systems), and the various embodiments described and claimed herein.

The present disclosure is directed to systems and methods for detecting and mitigating cyberattacks on grid-connected systems based on different rules that incorporate data streams from inbound and outbound communications. These data streams may include, for example, communications with devices on the grid-connected systems (e.g., IBR, DER, EVSE, and/or similar devices), forecasting tools, meteorological sensors, on-site or remote power sensors, meters, or databases, power system simulations or state estimations, or information about the operation of similar assets from other grid-connected systems.

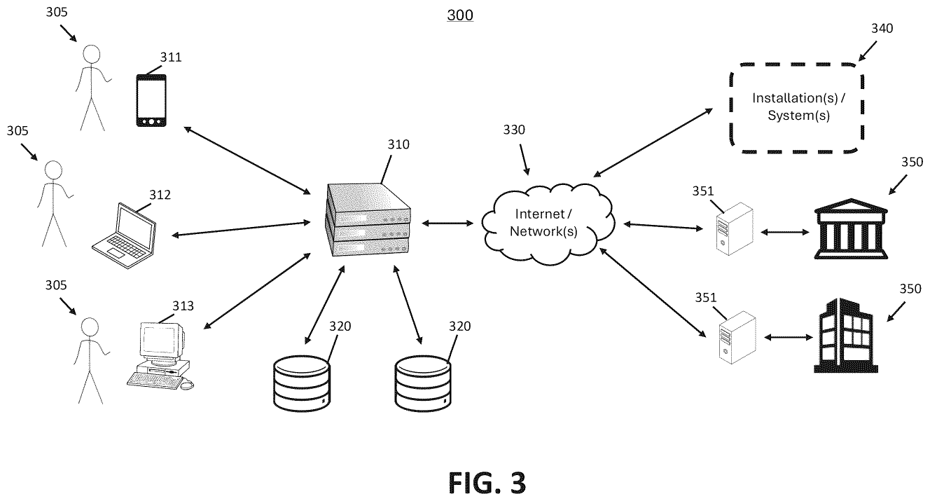

FIG. 3 shows an overview of an environment 300 in which the various embodiments described herein can be used. In accordance with embodiments, the environment 300 may provide access to networks, devices, and services for one or more users 305. The environment 300 may include user devices that allow for the storage and processing of information, and for communication with a network and other devices, such as through a service provider 310 and with each other. Such user devices may include mobile devices 311 such as cellular phones, tablets, personal data assistants, laptop computers 312, desktop computers 313, and the like. Mobile devices 311 may include portable devices, such as mobile phones, tablets, or other portable computing devices. The mobile devices 311 may use various types of software, including operating system software such as iOS, Android, or other operating system software suitable for such devices. Laptop computers 312, and desktop computers 313 may include operating system software such as Windows, Linux, Mac OS, or other operating system software suitable for such devices.

A user 305 of devices, systems, and methods associated with the environment 300 may access information by way of a software application running on a user device 311, 312, 313. Such a software application may be, for computing example, a mobile app or a standalone software application configured to run on a laptop or desktop computer device. Alternatively, a user may access information remotely, such as by way of a web page displayed by a web browser application, or by a client (e.g., Citrix) or thin client, supporting networked computing capabilities.

The environment 300 shown in FIG. 3 can include a service provider 310 to facilitate the communication of information to and from users, devices, and systems, such as those shown in FIG. 3. The service provider 310 may include one or more servers having hardware and software configured to store and process information, and to communicate with other system components to achieve the functionality described herein.

The service provider 310 may connect user devices 311, 312, 313, and/or other devices and system in the environment 300, to one or more databases 320. A database 320 may store information to be used in accordance with the system. Such information may include, for example, user information (e.g., user profiles), device information, communications information, and information associated with the various rules, comparisons, systems, and methods described herein. The devices and systems of the environment 300 are configured to use and communicate information, including the types of information stored in the databases 320 or otherwise described herein.

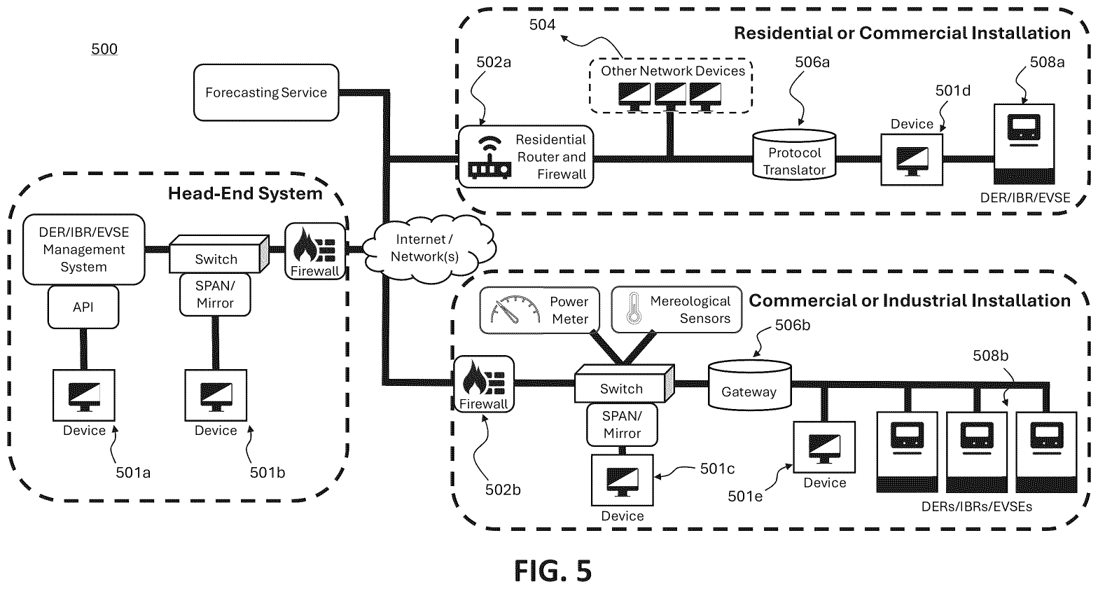

The service provider 310 can provide access to a number of other devices, businesses, and systems through the Internet or other networks 330. For example, the Internet or other networks 330 may provide access to other users 305 and user devices 311, 312, 313, similar to those shown in FIG. 3. The connecting network may be any suitable type of network, including, for example, a local area network (LAN), a wide-area network (WAN), a virtual private network (VPN) or other type of virtual network, or the Internet. The Internet/Network(s) 330 may also provide access to installations or systems 340, such as those discussed herein (including those discussed in connection with FIG. 5, below). In accordance with embodiments, the Installation(s)/System(s) 340 can include grid-connected systems, including systems with grid-connected communications equipment, power-conversion devices, or power-generation devices (e.g., IBR, DER, EVSE and/or similar systems)

The Internet/Network(s) 330 can also provide access to commercial computers and/or servers 351 associated with one or more businesses 350. The businesses can be of any type interested in connecting to the Internet/Network(s) 330 and/or the Installation(s)/System(s) 340, and they may access the Internet/Network(s) 330 via one or more computers or servers 351.

According to embodiments, the devices shown in the environment 300 of FIG. 3 may make use of one or more engineered control systems for grid-connected systems and/or devices. For example, one or more engineered control systems can be used with networked equipment, including equipment for grid-connected systems, incorporates advanced analytics of the operational processes to identify anomalous behaviors or controls.

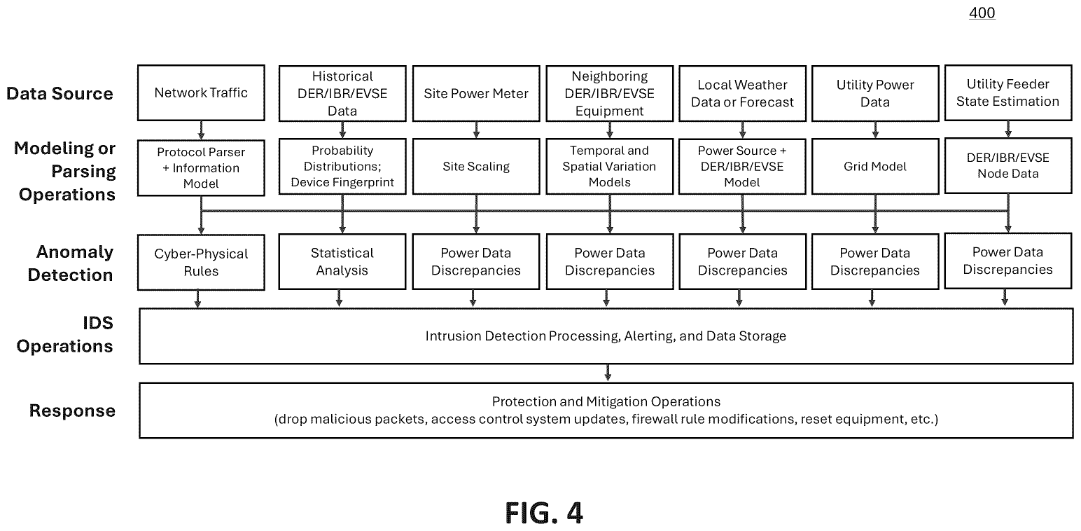

An example of an engineered control system logic 400 that can be used with the systems and methods described herein is shown in FIG. 4. For example, the engineered control system logic 400 shown in FIG. 4 may be used with or implemented via the devices shown in the environment 300 of FIG. 3. The engineered control system logic 400 may be used to detect anomalous behaviors, including for example, malicious commands or false data injection attacks, which could be detected using a number of techniques. For example, one or more of the following techniques could be used to detect anomalous behaviors: (a) comparing field measurements from power meters or sensors with inverter measurement data, (b) comparing consistency of measurement data, such as comparing the DC current, voltage, or power to AC current, voltage, or power, (c) comparing power characteristics of grid-connected systems to meteorological conditions recorded locally or forecast for the region, (d) detecting if there are unaccountable differences in power system data from multiple co-located, nearby, or remote sites, (e) fingerprinting the hardware operations based on the operational characteristics of the devices of grid-connected systems (e.g., IBR, DER, EVSE, and/or similar systems), such as by detecting small amounts of reactive power when set to unity power factor, (f) comparing the production of a grid-connected system and/or its devices to an analytical or numerical simulation of the equipment of such a system, a digital twin, or a machine learning model of the system, or (g) analyzing operational characteristics of a grid-connected system (e.g., IBR, DER, EVSE, and/or similar system) based on historical performance of the same system or similar systems.

According to one or more embodiments, intrusion detection software may run at several locations in the system. For example, embodiments are shown in FIG. 5. FIG. 5 is a diagram showing an example control system network architecture 500 for grid-connected systems with multiple example locations where the systems and methods described herein can be deployed in the network. As shown in FIG. 5, various devices 501 can be used to collect information and/or to implement the various rules, comparisons, systems and/or methods described herein. These devices 501 can be any type of computing device suitable for connecting to the systems and devices shown in FIG. 5. For example, the devices 501 of FIG. 5 can include, for example, the user devices 311, 312, 313 or the commercial computers and/or servers 351 shown in FIG. 3.

According to embodiments, a user can gather information from the head-end system (or management system) using a device 501a via an API or other data exchange with the management system. According to one or more embodiments, the systems and methods described herein may be deployed via a device 501b at the head-end of the system and connected via a specialized port or switch for monitoring and/or copying network traffic/communications, such as a Switched Port Analyzer (SPAN) or mirror port on the network switch or via a network tap within the head-end management system. The management system or head-end system can be connected to different installations or systems, such as a residential or commercial installation or a commercial or industrial installation. These installations or systems 340 are shown schematically in FIG. 3, as well as in FIG. 5. Such installations or systems may connect to the head-end system or other installations or systems by way of the Internet or other networks (e.g., LAN, WAN, VPN, etc.). A forecasting service or other similar analysis may also be connected via the Internet or another network. A number of devices are described below in connection with one or more of the installations shown in FIG. 5, but as will be appreciated, the environment of this figure is just an example and any of the devices can be used in any of the installations shown.

Embodiments of the systems and methods described herein can be deployed via the software on a router 502a or firewall 502b, other network devices 504, a protocol translator or gateway 506a, 506b, and by one or more grid-connected devices (e.g. DER, IBR, EVSE, or other similar device) 508a, 508b, respectively. In FIG. 5, these deployments are shown in residential, commercial, and industrial installations, but they could be in any of these as well as at the head-end system or aggregator locations along the communication pathway.

Embodiments of the systems and methods described herein can be deployed using a field implementation where the software runs on a computer platform or device 501c attached to a specialized port or switch, such as a SPAN or mirror port 504a, or on another network device 504. This implementation can also be realized using a device 501e, such as a network tap or other device, that replicates network traffic. Also shown in FIG. 5 is a deployment 501d which is a bump-in-the-wire implementation, where the hardware includes two network interfaces. The systems and methods described herein can analyze in the network the communication pathway, which enables the ability to drop ay network traffic determined to be malicious.

According to an embodiment, the system will detect and mitigate commands that are physically impossible, represent grid-harming behaviors, or are outside permitted operating ranges for the hardware, or that place the system in operating modes that are forbidden by the interconnection standard. This could include, for example, incorporating steep frequency-droop slopes, tight frequency and/or voltage trip settings, or inverting curve-based grid-support operating modes. Example interconnections standards include IEEE 1547-2018, Australian/New Zealand Standard (AS/NZS) 4777.2:2020, European Standards in the EN 50549 Series, VDE-AR-N 4105, CEI 0-21, etc., as well as the regional and local implementations of these standards. The system can detect and mitigate control commands or measurement operations, for example, in cases where (a) power, reactive power, current, and other parameters are set to values above the capacity of the equipment (e.g., the nameplate capacity), (b) the operating state is set in an operating mode that is disallowed by the area Electric Power System (EPS) operator or asset owner, or (c) the power setpoint is configured in opposition to transmission system or market needs.

In another embodiment, the system can detect anomalous communications based on application layer information presented, for example, between a grid-connected system (e.g., IBR, DER, EVSE, and/or similar system) and another communication system. Examples of these communications can include protocol exceptions, attempting to write read-only points, grid-connected device communication errors, or rejection messages for read or write operations of the grid-connected system.

In an embodiment, sensors at the site can collect weather information, such as temperature, wind speed, and irradiance. This type of information can then be fed through a model of the generation source and conversion equipment to estimate the active power, reactive power, or other data to compare to the production information of the grid-connected system. The measurement data can be queried directly from the equipment or gathered by passively monitoring the traffic on the network. The equipment model may be a machine learning model, analytical model, numerical model, or some other mathematical model of the power generation and conversion system.

According to one or more embodiments, the system can validate measurement data based on certain rules, such as electrical engineering rules or power rules, to compare parameters.

In an embodiment, the system can validate measurement data based on certain electrical engineering rules, such as comparing one or more of the following parameters:
a. Power factor (PF) to active (P) and reactive power (Q),
b. PF to P and apparent power(S),
c. PF to Q and S,
d. DC power to AC power,
e. Multiple DC inputs,
f. Line-Line voltages to Line-Neutral voltages,
g. Line 1, 2, and/or 3 P, Q, and S values to total P, Q, and S values.
   Depending upon the desired operation of the system, it may measure or compare other parameters than those shown above that are useful for validating measurements of the system.

The system can also validate measurement data, based on certain power rules, by correlating the power data to the enabled or commanded grid-support functions. This can be done, for example, by comparing one or more of the following parameters:
a. Commanded PF to measured PF and measured active/reactive power,
b. commanded reactive power to measured reactive power,
c. Enter Service min/max frequencies and voltages to measured frequency, voltage, and power,
d. Frequency-Droop Control to measured frequency and power,
e. Frequency-Droop Control to measured frequency and power,
f. High Frequency Trip Settings to measured frequency and power,
g. High Voltage Trip Settings to measured voltage and power,
h. Low Frequency Trip Settings to measured frequency and power,
i. Low Voltage Trip Settings to measured voltage and power,
j. Limit Active Power Settings to measured power,
k. Volt-Var curve to measured voltage and reactive power,
l. Volt-Watt curve to measured voltage and active power, and/or
m. Watt-Var curve to measured active and reactive power.
   Depending upon the desired operation of the system, it may measure or compare other parameters than those shown above that are useful for validating measurements of the system.

In another embodiment, forecasts can be gathered using Application Programming Interfaces (APIs), web scrapers, or other machine-to-machine exchanges, such as exchanges connected to weather services that provide information, such as local cloud cover, irradiance, temperature, wind speed, or other meteorological estimates for times. These time estimates may vary, for example, such as being between 1 second and 1 month in the future at intervals between 1 second and 24 hours. This forecasting information can be incorporated into algorithms to estimate current or future operational characteristics of the equipment and determine if there are abnormalities in the grid-connected system.

In another embodiment, measurement or control information for multiple grid-connected devices is compared to identify abnormalities given the spatial and temporal separation of the power system data points. These data points may include, for example, voltage, frequency, power, reactive power, or other data points useful for detecting system abnormalities. For example, spatial variability of PV systems has been extensively studied, and is described in the following paper: M. Lave, “A Wavelet-Based Variability Model (WVM) for Solar PV Power Plants,” IEEE Transactions on Sustainable Energy, 4(2), 2013. Similarly, the temporal variability of PV systems has also been extensively studied and is described in the following paper: J. Johnson, “Initial operating experience of the 1.2 MW La Ola photovoltaic system,” IEEE Photovoltaic Specialists Conference, 2012. Using this knowledge, outliers can be identified and flagged as anomalies (including cyber-physical anomalies), and/or possible false data injection attacks.

In an embodiment, a baseline “fingerprint” can be created for single device or class of devices (e.g., make, model, and/or firmware version) that defines or characterizes how the equipment behaves under different conditions. Fingerprints may be established, for example, by electrically characterizing a device or type of device, or by capturing a history of operations for a device or type of device in the field, in a laboratory, on from a simulation. The systems and methods described herein can then use one or more “fingerprint rules” for identifying or detecting anomalies, such as by comparing a device against a fingerprint or modeled fingerprint. The fingerprint rules used by the systems and methods described herein include, for example, grid-connected device class-level networking fingerprint IDS rules, grid-connected device-specific networking fingerprint IDS rules, cyber-physical fingerprint IDS rules, physical fingerprint IDS rules,

The following represents examples of possible grid-connected device class-level networking fingerprint IDS rules that can be used to identify anomalies:
a. Unexpected MAC Address OUI—the first six hexadecimal digits of a Media Access Control (MAC) address can be used as Organizationally Unique Identifiers (OUIs). They uniquely identify the manufacturer or vendor of the network interface card (NIC) or other device that has the MAC address.
b. Unexpected Open Communication Ports—any device ports that show as open on a device that are not normally open.
c. Unexpected Service Software—Nmap or similar service probes that show a service and/or its version number, running on a scanned port.
d. Unexpected Response to ICMP (Ping) Requests—If the device responds to ICMP/ping requests and the latency of this response.
e. Unexpected Protocol Address—Protocol addresses (e.g., Modbus Unit ID, DNP3 Address, etc.) are often fixed values for a given device class.
f. Unexpected Readback Time—Check the speed of the equipment in terms of the readback time after a setting is updated.
g. Unexpected Control Acceptance/Rejection Behavior—Device allows normally disallowed control/settings options or device rejects normally allowed control/settings options, indicating the device is being spoofed or has been compromised.
h. Unexpected Nameplate Information—The manufacturer, model, version, and software static values have changed.

The following represent examples of possible grid-connected device-specific networking fingerprint IDS rules that can be used to identify anomalies:
a. Modified MAC Address—The MAC address should never change for a given Network Interface Card (NIC).
b. Modified IP Address—Unless using software-defined routing, the IP address of the DER endpoint should remain static.
c. Unexpected Serial Number—The serial number for the device should never change.
d. Unexpected Protocol Address after Modification—Protocol addresses (e.g., Modbus Unit ID, DNP3 Address, etc.) are static after configuration.
e. Unexpected Traceroute—The number of traceroute hops, intermediate steps, and time per hop to communicate to the device will be consistent on most operational technology networks.
f. Modified Communication Patterns—A DER device configured as a client would periodically communicate with limited, pre-determined devices.

The following represents a subset of cyber-physical fingerprint IDS rules that can be used to detect anomalies:
a. Unexpected Control Response Time—The time it takes for the device to update the power behavior after changing a setting.
b. Mismatch between Physical Nameplate and Communicated Nameplate—The label on the side of the DER equipment should match the communication interface information.

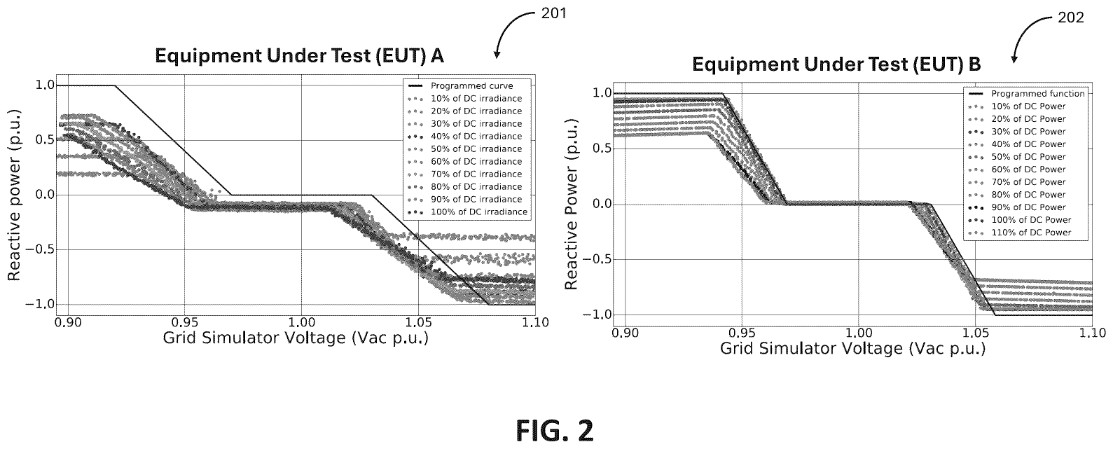

The following represents a subset of physical fingerprint IDS rules that can be used to detect anomalies:
a. Unexpected Temperature vs. Power Derating—The reduction in maximum active power limit as ambient, cabinet, or component temperatures increases.
b. Unexpected Efficiency—Converter DC/AC ratios are generally known for a range of AC power levels and DC voltage levels based on California Energy Commission (CEC) testing; see URL: https://solarequipment.energy.ca.gov/Home/InverterSolarList.
c. Unexpected Volt-Var Behavior—reactive power Q does not match the expected function of voltage and power f(V, P), output, such as is shown in FIG. 2. This functionality is represented in FIG. 2 for two different products. As shown in the Figure, the two devices have different offsets at nominal voltage and different characteristics compared to the programed volt-var curve (black lines).
d. Unexpected Volt-Watt Behavior—Power P does not match the expected function of voltage f(V) output.
e. Unexpected Watt-Var Behavior—Reactive power Q does not match the expected function of power f(P) output.
f. Unexpected Freq-Droop Behavior—Power P does not match the expected function of frequency f(f) output.
g. Unexpected Enter Service Behavior—Power P does not match the expected function of voltage and frequency f(V, f) output.
h. Unexpected Constant Power Factor Behavior—Power factor PF does not match the expected function of power f(P) output.
i. Unexpected Commanded Active Power Behavior—Power P does not match the expected function of some adjustable f(*) output (where *, as used herein, is a wildcard or variable that may change or be adjusted to represent any parameter(s)).
j. Unexpected Commanded Reactive Power Behavior—Reactive power Q does not match the expected function of some adjustable f(*) output.
k. Unexpected Prioritization Behavior—Power P or reactive power Q does not match the expected function of adjustable f(*) output
l. Unexpected Reversion Behavior—Power P or reactive power Q does not match the expected function of adjustable f(*) output
m. Unexpected Ramping Behavior—Power P or reactive power Q does not match the expected function of adjustable and time f(*, t) output
n. Unexpected Active vs Reactive Power Relationship—The higher active power the higher the reactive power bias for the system.
o. Unexpected Irradiance vs Power Relationship—When no grid-support functions are reducing active power, there is a relationship between irradiance and output power. This characteristic curve can only be created on a per-site basis because this relationship depends on the PV module technology, array topology, and DC/AC ratio of the inverter.

In another embodiment, meteorological, forecast, or power input data can be fed to a machine learning, artificial intelligence, analytical, or numerical model of the grid-connected system, to estimate physical characteristics (e.g., output power P, reactive power Q, apparent power S, power factor PF, etc.) This output can then be compared to measurements from the device or other power data from site meters, utility meters, state estimations, or other power estimates for the device or system to identify anomalies.

In another embodiment, historical data from the device or site can be used to predict the power from the system. An example of this approach would be a statistical representation of site power production based on time of day and month of the year. If production for a grid-connected system, or a site exceeded certain bounds (e.g., +/−3 standard deviations), the system would alert that it has detected abnormal operations.

The systems and methods described herein are described with reference to a number of different examples of rules, fingerprinting techniques, modeling techniques, and the like. Although a number of specific examples are described, it should be understood that different rules similar to those described above can also be used by the systems and methods described herein. By adapting the rules, fingerprinting techniques, and modeling techniques, different embodiments may be realized that are consistent with the principles described in this document.

It should be recognized that certain components or elements of the embodiments described above, or in the claims that follow, are numbered to allow ease of reference to them or to help distinguish between them, but order or limitation should not be implied from such numbering, unless such order or limitation is expressly recited. The above description and drawings are only to be considered illustrative of specific embodiments, which achieve the features and advantages described herein. Accordingly, the embodiments in this patent document are not considered as being limited by the foregoing description and drawings.

What is claimed is:

1. A system comprising:
a detector configured to receive communication data in a grid-connected system;
a receiver configured to extract operational data from the received communication data associated with a device operating within a grid-connected system; and
a processor configured to analyze the extracted operational data, and determine if there is an anomaly within the grid-connected system.

2. The system of claim 1, wherein the grid-connected system is a system using inverter-based resources (IBR)

3. The system of claim 1, wherein the grid-connected system is a system using distributed energy resources (DER).

4. The system of claim 1, wherein the grid-connected system is a system using vehicle supply equipment (EVSE)

5. The system of claim 1, wherein the processor analyzes the extracted operational data based on information from an engineered control system.

6. The system of claim 1, wherein the processor analyzes the extracted operational data based on a pre-determined rule.

7. The system of claim 6, wherein the processor analyzes the extracted operational data based on an electrical engineering rule.

8. The system of claim 6, wherein the processor analyzes the extracted operational data based on a power rule.

9. The system of claim 6, wherein the processor analyzes the extracted operational data based on a fingerprint rule.

10. The system of claim 9, wherein the processor analyzes the extracted operational data based on a grid-connected device class-level networking fingerprint IDS rule.

11. The system of claim 9, wherein the processor analyzes the extracted operational data based on a grid-connected device-specific networking fingerprint IDS rule.

12. The system of claim 9, wherein the processor analyzes the extracted operational data based on a cyber-physical fingerprint IDS rule.

13. The system of claim 9, wherein the processor analyzes the extracted operational data based on a physical fingerprint IDS rule.

14. The system of claim 1, wherein the processor analyzes the extracted operational data based on historical data.

15. The system of claim 1, wherein the processor analyzes the extracted operational data based on modeled, forecast, or predictive data.

16. The system of claim 1, wherein the processor analyzes the extracted operational data based on data representing a real-world condition.

17. The system of claim 1, wherein the processor analyzes the extracted operational data by comparing the extracted operational data with other real or modeled operational data.

18. The system of claim 1, wherein the processor provides a notification of any anomaly discovered within the grid-connected system.

19. A method comprising:
receiving communication data in a grid-connected system;
extracting operational data from the received communication data associated with a device operating within a grid-connected system; and
determining, based on the extracted operational data, if an anomaly exists within the grid-connected system.

20. The method of claim 19, wherein grid-connected system from which communication data is received is selected from the group of: an inverter-based resource (IBR), a distributed energy resource (DER), and a vehicle supply equipment (EVSE).

21. The method of claim 19, further comprising analyzing the extracted operational data based on information from an engineered control system.

22. The method of claim 19, wherein the determination if an anomaly exists is made based on a pre-determined rule.

23. The method of claim 22, wherein the determination if an anomaly exists is made in response to a rule selected from the group of: an electrical engineering rule, a power rule, and a fingerprint rule.

24. The method of claim 23, where the determination if an anomaly exists is made in response to a fingerprint rule selected from the group of: a grid-connected device class-level networking fingerprint IDS rule, a grid-connected device-specific networking fingerprint IDS rule, a cyber-physical fingerprint IDS rule, and a physical fingerprint IDS rule.

25. The method of claim 19, wherein the determination if an anomaly exists is made based on historical data.

26. The method of claim 19, wherein the determination if an anomaly exists is made based on modeled, forecast, or predictive data.

27. The method of claim 19, wherein the determination if an anomaly exists is made based on data representing a real-world condition.

28. The method of claim 19, wherein the determination if an anomaly exists is made based on comparing the extracted operational data with other real or modeled operational data.

29. The method of claim 19, further comprising:
providing notification of any anomaly determined to exist.

30. The method of claim 19, further comprising:
mitigating an anomaly determined to exist.

31. A system comprising:
a means for detecting communication data in a grid-connected system;
a means for extracting operational data from the received communication data associated with a device operating within a grid-connected system; and
a means for determining if there is an anomaly within the grid-connected system.

32. The system of claim 30, wherein grid-connected system from which communication data is detected is selected from the group of: an inverter-based resource (IBR), a distributed energy resource (DER), and a vehicle supply equipment (EVSE).

33. The system of claim 30, further comprising a means for analyzing the extracted operational data based on information from an engineered control system.

34. The system of claim 30, further comprising a means for analyzing the extracted operational data based on a pre-determined rule.

35. The system of claim 33, wherein the means for analyzing the extracted operational data analyzes the extracted operational data based on a rule selected from the group of: an electrical engineering rule, a power rule, and a fingerprint rule.

36. The system of claim 34, wherein the means for analyzing the extracted operational data analyzes the extracted operational data based on a fingerprint rule selected from the group of: a grid-connected device class-level networking fingerprint IDS rule, a grid-connected device-specific networking fingerprint IDS rule, a cyber-physical fingerprint IDS rule, and a physical fingerprint IDS rule.

37. The system of claim 30, further comprising a means for analyzing the extracted operational data based on historical data.

38. The system of claim 30, further comprising a means for analyzing the extracted operational data based on modeled, forecast, or predictive data.

39. The system of claim 30, further comprising a means for analyzing the extracted operational data based on data representing a real-world condition.

40. The system of claim 30, further comprising a means for analyzing the extracted operational data based on comparing the extracted operational data with other real or modeled operational data.

41. The system of claim 30, further comprising a means for providing notification of any anomaly determined to exist.

42. The system of claim 30, further comprising a means for mitigating an anomaly determined to exist.

43. A computer-readable medium, having instructions stored thereon that, when executed, cause a computer to perform the steps of:
receiving communication data in a grid-connected system;
extracting operational data from the received communication data associated with a device operating within a grid-connected system; and
determining, based on the extracted operational data if an anomaly exists within the grid-connected system.

44. The computer-readable medium of claim 41, further comprising instructions stored thereon that, when executed, cause a computer to perform the step of:
analyzing the extracted operational data based on a pre-determined rule.
